(19) United States
(12) Patent Application Publication
(10) Pub. No.: US 2012/0180280 A1
(43) Pub. Date: Jul. 19, 2012

(54) Hydraulically Activated Tension Relief System for Threaded Fasteners

(76) Inventor: Michael James Psimas, Milton, GA (US)

(21) Appl. No.: 13/007,638

(22) Filed: Jan. 16, 2011

(51) Int. Cl. B23P 19/06

(52) U.S. Cl. 29/252

(57) ABSTRACT

A tension relief system for threaded fasteners comprises a main body housing a piston for generating a clamping load, seals to maintain the hydraulic pressure within the pressure chamber, an external pressure port extending through the body to the pressure chamber and adapted to be connected to an external pressure source, a connector on which the main body may be mounted, and a spring which may be compressed through the relative motion of the piston and the connector.

### FIELD OF THE INVENTION

The present invention relates to a hydraulically activated tension relief system for threaded fasteners. More specifically, the present invention relates to the use of a hydraulic ram to eliminate the tensile load in a bolt.

### BACKGROUND OF THE INVENTION

A common complication that arises when fastening or disassembling threaded components is galling which can result in damage to the threaded features or seizing of said components. Such damage or seizing can often be costly to repair or remedy. Galling is a form of adhesive wear and material transfer between metallic surfaces during operations in which relative motion of said surfaces is involved. The fastening of threaded components in which interlocking threaded features are slid past each other under high loads is an industrial operation which is notably prone or vulnerable to galling. Galling is a major concern in said application because the same features which promote galling, such as material ductility, metal on metal contact, friction, and high compressive loads, are not only present, but are indeed necessary features for operation.

However, galling can also occur at relatively low loads since localized pressure and energy density are greater than their respective macroscopic values. It is these local values which can result in elevated friction, promote material transfer, and induce phase transition. When two metallic surfaces, such as complimentary screw threads, are forced together, the high points or asperities found on each surface are the initial mating points. It is possible for said asperities to penetrate the opposing surface upon application of relative movement, thereby initiating plastic deformation and frictional forces between said surfaces. The induced pressure is highly localized, and the small region upon which the pressure is applied is termed the contact zone. As consequences of the pressure elevation, friction heating and adhesive forces increase, thereby resulting in initiation of material transfer, creation of additional protrusions, and growth of said protrusions. Furthermore, galling is especially likely when disassembling threaded fasteners which have been in service for several years due to additional debris from local oxidation, foreign contaminants, and the breakdown, seepage, and removal of assembly lubricants.

The high ductility of commonly used machine screws can be considered a requisite characteristic for substantial material transfer and galling. Frictional heating is greatly related to the size, shape, and material properties of the plastic zones that surround the penetrating objects. Correspondingly, brittle fractures rarely generate copious amounts of heat due to the small, transitory plastic zones. If the height of the protrusion grows larger than a critical threshold value, it may penetrate the brittle oxide layer of the complimentary mating surface. As a result, said protrusion could cause damage to the ductile bulk material on which the oxide layer originally formed, thus creating a region of plastic flow around said protrusion. Thus, the geometry, loading conditions, and relative motion of the protrusion govern the material flow, contact pressure, and thermal profile during sliding.

In the dynamic sliding contact of nut torqueing, increasing axial compressive force is proportionally equal to a rise in potential energy and thermal energy in the aforementioned localized system. Thus, the high loads and relative rotation associated with the torqueing of threaded nuts onto and off of threaded counterparts are particularly susceptible to galling. Additionally, as the nut is turned further and sliding progresses, additional energy is supplied to the system. Initially there is limited energy loss in the system (contact zone) since heat conduction away from the contact zone is significantly inhibited by the relatively small cross sectional area for thermal transport, and correspondingly low conductance, on the system boundary. The result is a corresponding increase in energy density and temperature in the contact zone, and said energy accumulation can damage the contact surfaces and alter their plastic behavior. Furthermore, the combination of direct contact and plastically deforming flow fields can result in the constitution of a common plastic zone in which the high energy density, pressure, and temperature promote inter-surface bonding. Generally, this greatly increases apparent adhesion as well as the force needed for further nut advancement or removal. In some cases this can cause seizing of the nut onto the threaded component, and removal of said nut requires time-consuming or destructive techniques such as cutting of the nut or screw. Reducing or eliminating the compressive load between threads greatly reduces the likelihood of galling due to a decrease in localized potential energy and frictional heating in the system.

One possible method of galling prevention is the use of a tensioning system to stretch the bolt before turning the nut off However, this process can be time intensive. Furthermore, said tensioning method involves increasing the compressive load on the bolted component, which may be undesirable in some circumstances.

There is therefore a need for a tension relief system which obviates the aforementioned problems.

### OBJECTS OF THE INVENTION

Accordingly, an object of this invention is the prevention of galling threaded features during the disassembly of bolted assemblies by reducing the load on said threaded features prior to disassembly.

Another object of this invention is the reduction of the load on the aforementioned threaded features without a corresponding increase of the axial tensile bolt load.

An additional object of the invention is to increase the speed of the disassembly process of bolted assemblies by requiring only quick hydraulic connections and pressurization and eliminating the slow processes of torqueing or tensioning.

Other objects and advantages of the present invention will become obvious to the reader upon an understanding of the illustrative embodiments about to be described or will be indicated in the claims, and various advantages not referred to herein will occur to one skilled in the art upon employment of the invention in practice.

### BRIEF SUMMARY OF THE INVENTION

To attain these and other objects which will become more apparent as the description proceeds according to one aspect of the present invention, there is provided a hydraulically activated tension relief system.

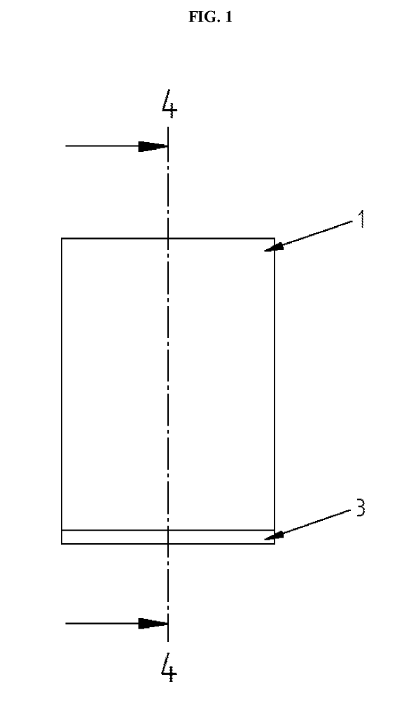

More specifically, in accordance with the present invention, there is provided a tension relief system for threaded fasteners (FIGS. 1 to 4) comprising an outer body (1), an inner piston (2), a pressure area (7) defined between the outer body and inner piston, sealing means (5) located between the outer body and inner piston, a compression disk spring (4), a connector (3) for attachment to the outer body. The outer body also includes an external pressure port (6) extending through the body to the pressure area (7) and adapted to be connected to an external pressure source. The sealing means (5) can be of a variety of standard elastomeric seals or of metal construction.

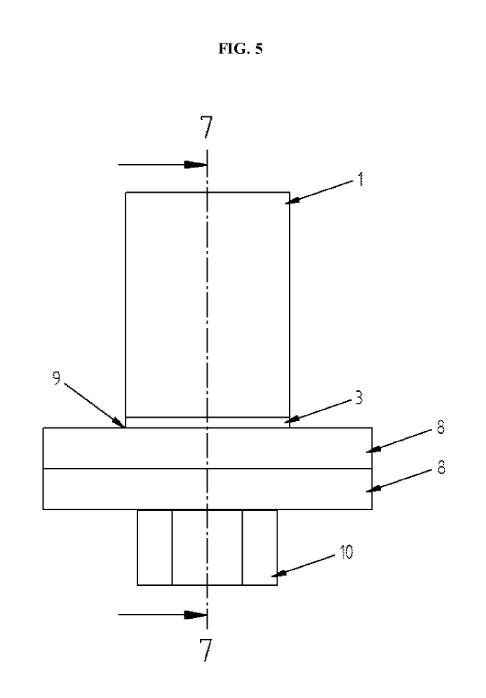

There is also provided a tension relief system (FIGS. 5 to 11) combined with a threaded bolt (10) and a threaded nut (11) to clamp work pieces (8) together. The tension relief system comprises an outer body (1), an inner piston (2), a pressure area (7) defined between the outer body and inner piston, sealing means (5) located between the outer body and inner piston, a compression disk spring (4), a connector (3) for attachment to the outer body. The outer body also includes an external pressure port (6) extending through the body to the pressure area (7) and adapted to be connected to an external pressure source. The sealing means (5) can be of a variety of standard elastomeric seals or of metal construction. When the tension relief system is not activated hydraulically, the tensile load of the bolt (10) partially compresses the spring (4) between the nut (11) and the connector (3). Thus, the connector bears (9) against the work piece (8) and the tension relief system becomes part of the bolted assembly. When activated hydraulically, the piston (2) bears on the nut (11), thereby further compressing the spring (4) and reducing the tensile load in the bolt (10). This reduction of the tensile load in the bolt (10) corresponds to a reduction in the forces on the threaded features of the nut (11) and the bolt (10); thus, the bolted assembly may be disassembled with minimal risk of galling.

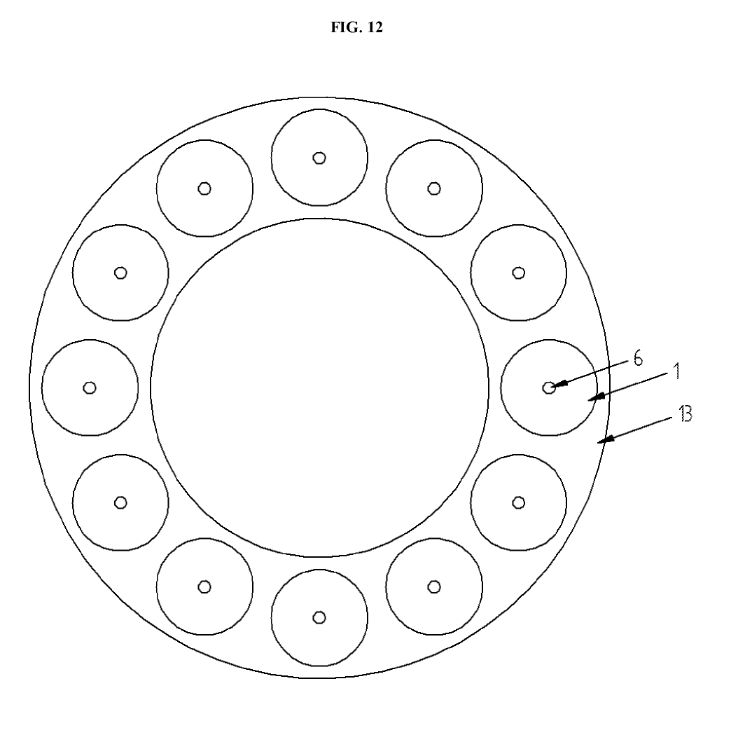

There is also provided an embodiment with multiple tension relief systems (FIGS. 12 to 15) combined with threaded bolts (10) and threaded nuts (11) to clamp common flanges (13) together. The tension relief systems each comprise of an outer body (1), an inner piston (2), a pressure area (7) defined between the outer body and inner piston, sealing means (5) located between the outer body and inner piston, a compression disk spring (4), a connector (3) for attachment to the outer body. The outer body also includes an external pressure port (6) extending through the body to the pressure area (7) and adapted to be connected to an external pressure source. The sealing means (5) can be of a variety of standard elastomeric seals or of metal construction.

Other aspects and advantages will be more readily apparent as the present invention becomes better understood by reference to the following detailed description and considered in connection with the accompanying drawings in which like reference symbols designate like elements throughout the figures.

The features of the present invention which are believed to be novel are set forth with particularity in the appended claims.

BRIEF DESCRIPTION OF THE SEVERAL VIEWS OF THE DRAWING

FIG. 1 is a side view showing the tension relief system assembly according to an embodiment of the present invention.

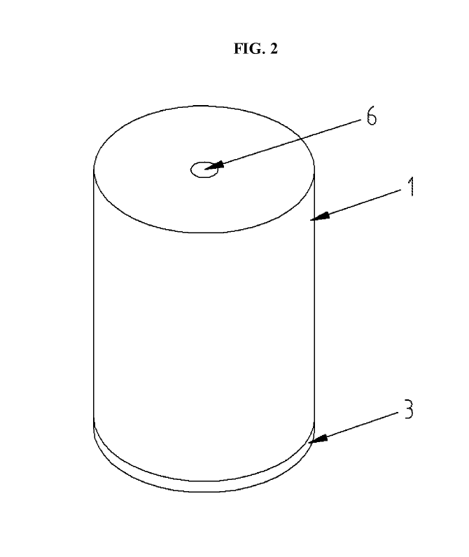

FIG. 2 is an isometric view of FIG. 1 showing the hydraulic port of the tension relief system assembly.

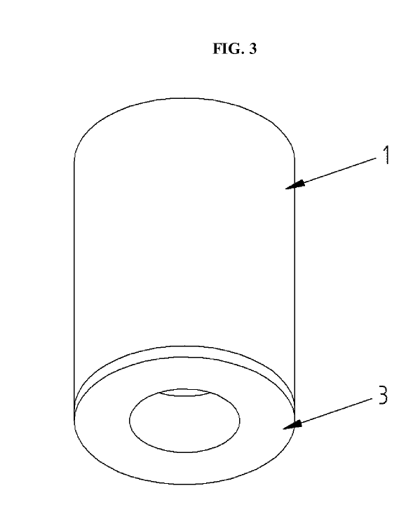

FIG. 3 is an alternate isometric view of FIG. 1 showing the connector piece of the tension relief system assembly.

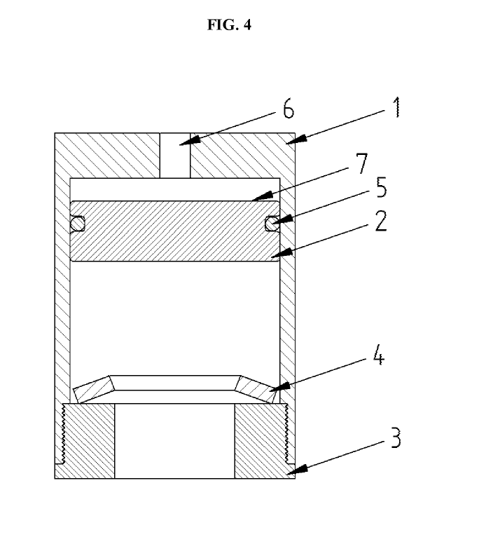

FIG. 4 is a full section view of FIG. 1 showing internal piston and disc spring of the tension relief system assembly.

FIG. 5 is a side view of a tension relief system with a bolted assembly including a headed bolt and two clamped work pieces.

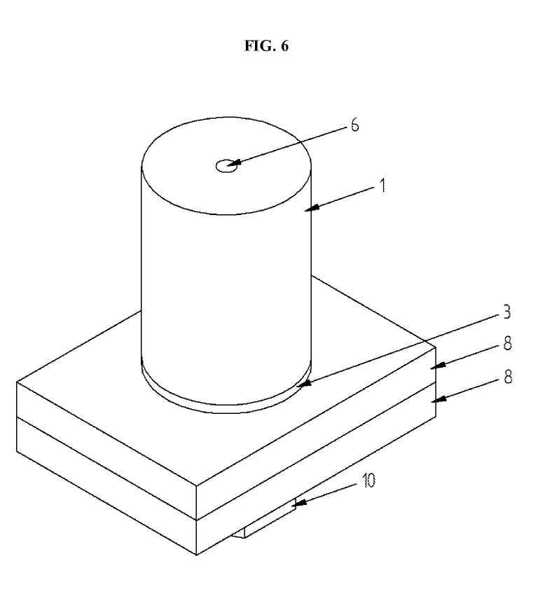

FIG. 6 is an isometric view of FIG. 5 showing a tension relief system with a bolted assembly including a headed bolt and two clamped work pieces.

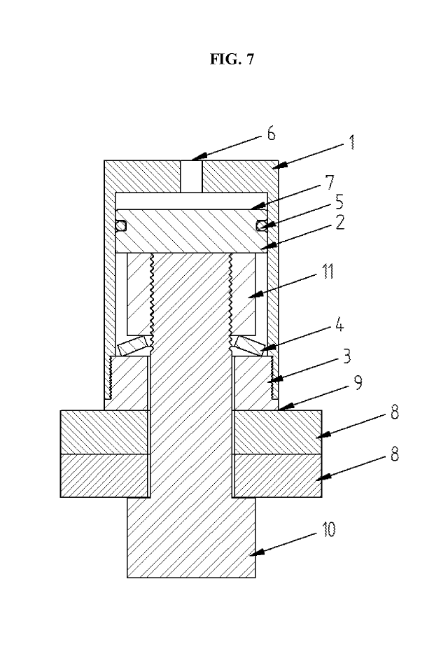

FIG. 7 is a full section view of FIG. 5 showing a tension relief system with a bolted assembly including a headed bolt, a nut, and two clamped work pieces.

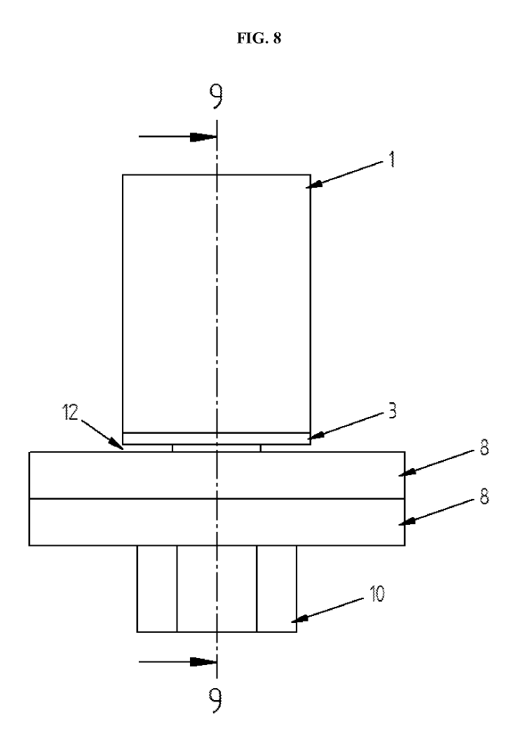

FIG. 8 is a side view of an activated tension relief system with a bolted assembly including a headed bolt, two clamped work pieces, and a gap between the connector and work piece.

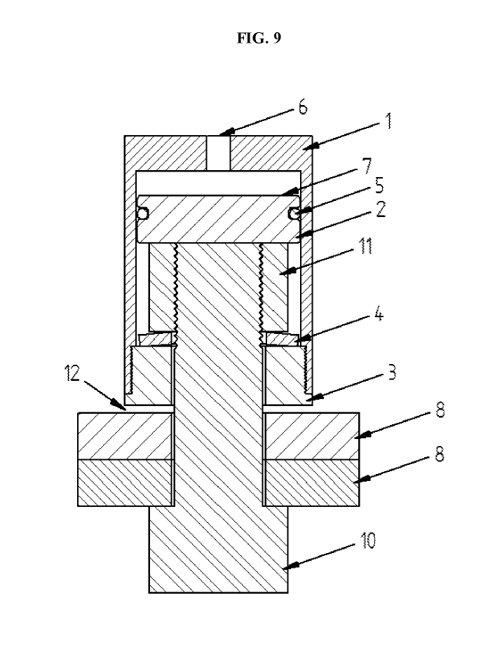

FIG. 9 is a full section view of FIG. 8 showing an activated tension relief system with a bolted assembly including a compressed spring and a gap between the connector and work piece.

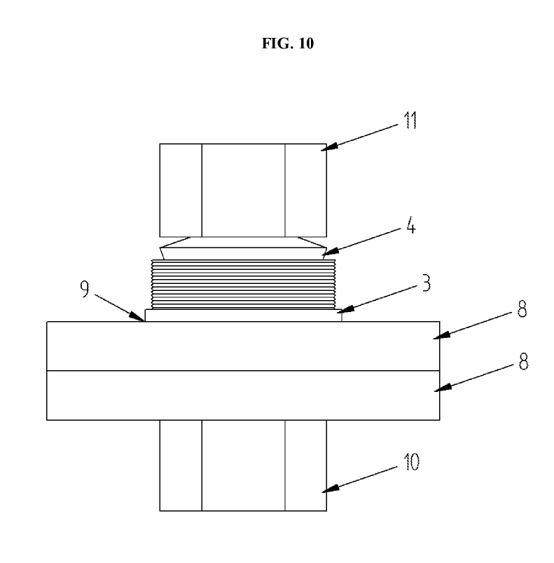

FIG. 10 is a side view of the lower portion of the tension relief system with a bolted assembly including a headed bolt and two clamped work pieces.

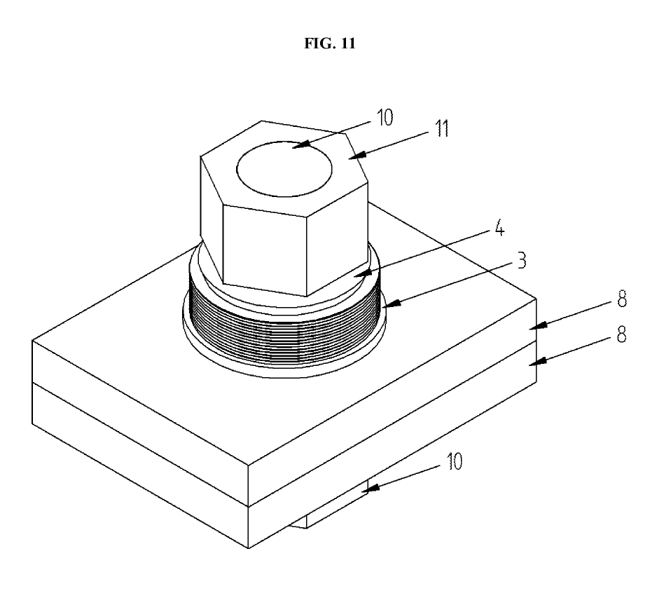

FIG. 11 is an isometric view of FIG. 10 showing the lower portion of the tension relief system with a bolted assembly including a headed bolt and two clamped work pieces.

FIG. 12 is a top view of multiple tension relief systems with a bolted assembly including headed bolts and two clamped circular flanges.

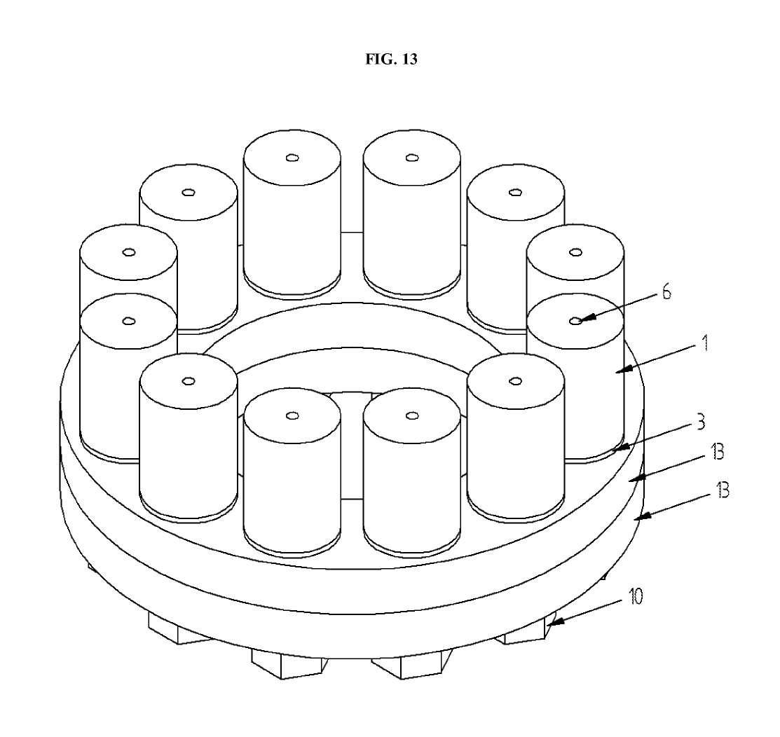

FIG. 13 is an isometric view of FIG. 12 showing multiple tension relief systems with a bolted assembly including headed bolts and two clamped circular flanges.

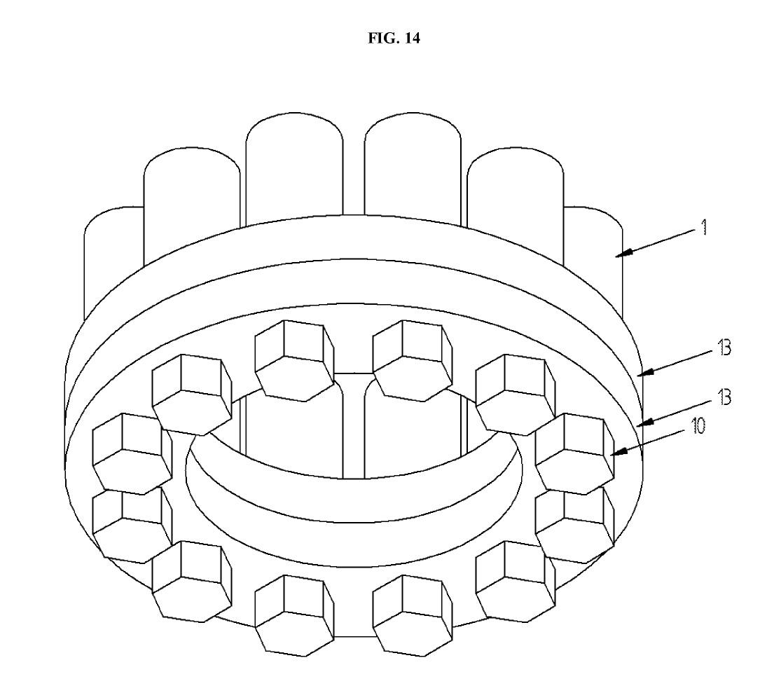

FIG. 14 is an alternate isometric view of FIG. 12 showing multiple tension relief systems with a bolted assembly including headed bolts and two clamped circular flanges.

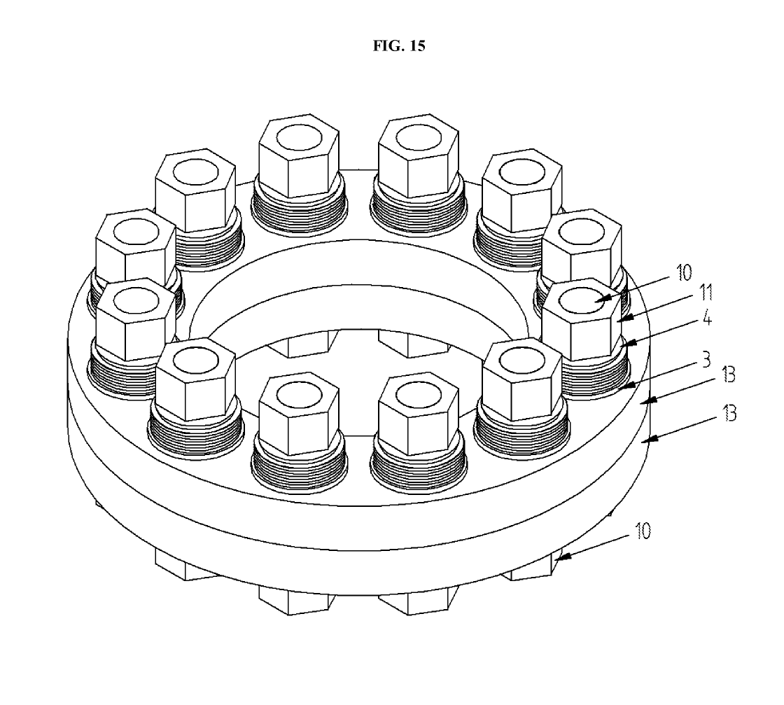

FIG. 15 is an isometric view of the lower portion of multiple tension relief systems with a bolted assembly including headed bolts and two clamped circular flanges showing the disc springs and connectors.

### DETAILED DESCRIPTION OF THE INVENTION

With reference to the annexed figures, the preferred embodiments of the present invention will be herein described for indicative purposes and by no means represent limitations.

The figures and description attached to it are only intended to illustrate the idea of the invention. As to the details, the invention may vary within the scope of the claims. So, the size and shape of the tension relief system may be chosen to best fit the fastened assembly.

Also, as used hereinabove and hereinafter, the term “stud” generally refers to stud, bolt, rod and other similarly shaped fasteners used in securing assemblies.

In accordance with the present invention, there is provided a tension relief system for threaded fasteners (FIGS. 1 to 15) comprising an outer body (1), an inner piston (2), a pressure area (7) defined between the outer body and inner piston, sealing means (5) located between the outer body and inner piston in an annular groove, a compression disk spring (4), a connector (3) for attachment to the outer body. The outer body also includes an external pressure port (6) extending through the body to the pressure area (7) and adapted to be connected to an external pressure source. The sealing means (5) can be of a variety of standard elastomeric seals or of metal construction.

The skilled addressee will readily understand that depending on the use and final location of the tension relief system, different types of seals (5) could be used. Elastomeric, elastic, metallic and/or non-metallic seals are all contemplated. Moreover, ring seals, C-shaped seals, U-shaped seals and seals of other shapes are also contemplated.

A first embodiment of the present invention is best shown in FIGS. 5 to 11. Its components comprise a threaded connector (3) that mates (9) up against a flange assembly (8) on one side and a disc spring (4) on the opposite side. A stud (10), or bolt with nut, is inserted through the connector, the spring, and the corresponding flanges that are mating together. The stud (10) can be threaded into the mating flange or to a mating flange that has a through hole and wherein the stud (10) threads into a standard nut on the mating flange. The stud bolt (10) can have an integral hex head (see FIGS. 5, 8, 10, and 11) to allow it to be turned into place using external means, such as a hex socket. The spring (4) is therefore partially compressed between the connector (3) and the nut (11).

With the stud bolt (10) in place, as shown in FIGS. 10 and 11, the outer body (1) can be mated with the connector (3) as shown in FIGS. 5 to 7. Fluid is introduced through an external hydraulic connector (6) that is ported to the hydraulic area (7). Hydraulic pressure from an external pump source (not shown) is now applied to the pressure area (7) in the assembly. As pressure is applied against the hydraulic area (7), axial load is generated on the piston (2). This load pushes down on the nut (11) whilst pulling up against the connector (3). As the load is applied, the resultant forces will further compress the spring (4). The resultant movement of the spring (4) in an axial direction of the stud bolt (10) will move the connector (3), resulting in a gap (12) formed between the mating surfaces of the connector (3) and flange (best shown in FIGS. 8 and 9). Thus, the bolt stretch is alleviated and the tensile bolt load is reduced. The bolt load reduction corresponds to a reduction in the forces on the threaded features of the nut (11) and the bolt (10). Thus, the bolted assembly may be disassembled with minimal risk of galling by turning the nut (11) and tension relief system simultaneously and/or manipulation of other members of the bolted assembly.

It is to be understood that even though a stud (10) with an integral head has been shown, the use of other types of studs and other types of mating techniques between the studs and flanges (8) are also contemplated. For example, the mating of the stud (10) with the lower flange (8) could be effected with a normal threaded nut which is threaded down a stud until it abuts on and mates with the flange (8). Therefore, the present invention is not limited to a particular mating technique between the studs (10) and flanges (8).

Also, it is to be understood that even though a threaded connector (3) has been shown, the use of other types of mating techniques between the outer body (1) and the connector (3) are also contemplated. For example, the mating of the outer body (1) with the connector (3) could be effected with normal machine screws and threaded holes. Therefore, the present invention is not limited to a particular mating technique between the outer body (1) and the connector (3).

Furthermore, it is to be understood that even though a disk spring (4) has been shown, the use of other types of springs are also contemplated. For example, the spring could be a coil spring, a wave spring, a gas spring, a cantilever spring, or one of many other compression spring designs. Additionally, it is to be understood that even though a single spring (4) has been shown, the use of multiple springs is also contemplated. Therefore, the present invention is not limited to a particular type of compression spring. The present invention is also not limited to a single spring.

In another embodiment, the multiple instances of the present invention are shown installed on the face of a circular flange (FIGS. 12 to 15). The stud bolts (10) are inserted through the connectors (3), the springs (4), and the corresponding flanges (13) that are mating together.

Obviously, even if only one shape of tension relief system has been shown and described, the skilled addressee will understand that the outer body (1), spring (4), piston (2), and connector (3) of the present invention could be provided in a variety of shapes and sizes according to the specific needs of a specific flange assembly.

Thus, although preferred embodiments of the invention have been described in detail herein and illustrated in the accompanying figures, it is to be understood that the invention is not limited to these precise embodiments and that various changes and modifications may be effected therein without departing from the scope or spirit of the present invention.

The invention claimed is:

1. A tension relief system for aiding in the disassembly of bolted assemblies, said tension relief system comprising:
a. an outer body having formed therein a substantially cylindrical bore;
b. a substantially cylindrical inner piston, with said inner piston being respectively received into said bores of said outer body for relative movements with respect to said outer body, said inner piston defining a substantially circular face such that said bore of said outer body and said circular face of said inner piston define a substantially cylindrical pressure cavity therebetween;
c. at least one external hydraulic pressure port extending through said outer body between said bore and the exterior of said outer body; wherein when hydraulic fluid is pumped through said external hydraulic pressure port, said hydraulic fluid flows to said pressure cavity;
d. at least one spring, wherein said spring is at least partially compressed as a result of the bolt load, wherein the overall height of said spring in the direction of the axis of said bolt is reduced upon application of hydraulic pressure in said pressure cavity, where said height reduction of said spring results in decreased bolt load;
e. a connector which becomes part of the bolted assembly, where said spring is compressed between said connector and the bolt head, wherein said connector is configured to mate with said outer body such that increasing hydraulic pressure in said pressure cavity forces said connector and said inner piston closer together.

2. A tension relief system as claimed in claim 1, wherein said outer body is an elongated structure.

3. A tension relief system as claimed in claim 1, wherein said outer body is a curved structure.

4. A tension relief system as claimed in claim 3, wherein said outer body is an endless curved structure.

5. A tension relief system as claimed in claim 1, wherein inner piston further comprises an annular groove located adjacent to said circular face of said inner piston, and wherein a seal is located in said annular groove.

6. A hydraulic nut as claimed in claim 1, wherein said bore of said outer body further comprises an annular groove located adjacent to said circular face of said inner piston, and wherein a seal is located in said annular groove.

7. A tension relief system as claimed in claim 1, wherein said spring is a disk type compression spring.

8. A tension relief system as claimed in claim 1, wherein said spring is a coil type compression spring.

9. A tension relief system as claimed in claim 1, wherein said spring is a wave type compression spring.

10. A tension relief system as claimed in claim 1, wherein said spring is a gas type compression spring.

11. A tension relief system as claimed in claim 1, wherein said spring is an elastic solid type compression spring.
